(19) United States
(12) Patent Application Publication
(10) Pub. No.: US 2011/0189534 A1
(43) Pub. Date: Aug. 4, 2011

(54) RECHARGEABLE BATTERY

(76) Inventors: Jun-Sik Kim, Yongin-si (KR); Sung-Soo Kim, Suwon-si (KR)

(21) Appl. No.: 12/947,639

(22) Filed: Nov. 16, 2010

(30) Foreign Application Priority Data
Feb. 4, 2010 (KR) 10-2010-0010444

(51) Int. Cl. H01M 2/06

(52) U.S. Cl. 429/179

(57) ABSTRACT

A rechargeable battery includes an electrode assembly that undergoes charging and discharging. The rechargeable battery includes a tube body that receives the electrode assembly and that has a tubular shape with a first open end and a second open end. A first film cover is installed at the first end of the tube body to seal the first end of the tube body, and a second film cover is installed at the second end of the tube body to seal the second end of the tube body.

### CROSS-REFERENCE TO RELATED APPLICATION

This application claims the benefit of Korean Application No. 10-2010-0010444, filed Feb. 4, 2010, in the Korean Intellectual Property Office, the disclosure of which is incorporated herein by reference.

### BACKGROUND OF THE INVENTION

1. Field of the Invention

Aspects of the present invention relate to a rechargeable battery, and more particularly, to a rechargeable battery with an improved case structure.

2. Description of the Related Art

A rechargeable battery differs from a primary battery in that it can be repeatedly charged and discharged, while the latter only performs irreversible conversion of chemical energy to electrical energy. The small-capacity rechargeable battery is used as a power supply for small electronic devices, such as cellular phones, notebook computers, and camcorders, while the large-capacity rechargeable battery is used as a power supply for driving motors or as a power storage battery in hybrid vehicles and the like.

A large capacity high power rechargeable battery using a non-aqueous electrolyte with a high energy density has been recently developed. The large capacity high power rechargeable battery is constructed with a high power battery module having a plurality of rechargeable cells coupled to each other in series or in parallel such that it can be used in electric vehicles requiring high power.

Furthermore, a high power rechargeable battery may be formed with a plurality of rechargeable batteries commonly connected to each other in series or in parallel, and the rechargeable battery may have a cylindrical shape or a prismatic shape.

The rechargeable battery is typically enveloped with a metal can or a filmed pouch case. However, the pouch battery may be weak against external impacts, and may have difficulty in heat dissipation. Furthermore, as no outward shape fixing structures are present therewith, it may difficult to fabricate a battery module through laminating. Meanwhile, although the metal can battery has high structural integrity, a metal can battery weighs much more than a pouch battery.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of the present invention provide a rechargeable battery having enhanced output power per unit weight.

An exemplary embodiment of the present invention provides a rechargeable battery including an electrode assembly that undergoes charging and discharging, and a tube body accommodating the electrode assembly therein. The tube body has a tubular shape with a first open end and a second open end. A first film cover is installed at the first end of the tube body to seal the first end of the tube body, and a second film cover is installed at the second end of the tube body to seal the second end of the tube body.

According to a non-limiting aspect, the tube body may be rigid and may be made of a metal or a polymer. The first film cover may comprise a first film body and a second film body that are attached to each other.

According to a non-limiting aspect, the first film cover may have an opening formed by spacing the first film body and the second film body apart from each other at one side of the first film cover. The opening accommodates the first end of the tube body. The first film cover may include an attachment flange where the first film body and the second film body are attached to each other. The attachment flange may be formed along a lateral side of the first film cover.

According to a non-limiting aspect, a first terminal may be installed at the first film cover such that it is electrically connected to the electrode assembly and protrudes between the first and second film bodies.

According to a non-limiting aspect, a first terminal that it is electrically connected to a positive electrode of the electrode assembly may protrude through the first film cover, while a second terminal electrically connected to a negative electrode of the electrode assembly may protrude through the second film cover. Alternatively, a first terminal electrically connected with a positive electrode of the electrode assembly and a second terminal electrically connected with a negative electrode of the electrode assembly may be formed at the first film cover such that each terminal protrudes between the first and second film bodies of the first film cover.

According to a non-limiting aspect, the first and second film bodies may be formed of a single polymer layer. Alternatively, the first and second film bodies may be formed of a laminated film where polymer layers are attached on both sides of a metal.

According to a specific exemplary embodiment, a rechargeable battery includes an electrode assembly including a first electrode and a second electrode; a tube body accommodating the electrode assembly therein, the tube body having a tubular shape with a first open end and a second open end; a first film cover installed at the first end of the tube body to seal the first end of the tube body; a first terminal connected to the first electrode, wherein the first terminal protrudes through the first film cover at the first end of the tube body; a second film cover installed at the second end of the tube body to seal the second end of the tube body; and a second terminal connected to the second electrode, wherein the second terminal protrudes through the second film cover at the second end of the tube body.

According to another specific embodiment, a rechargeable battery includes an electrode assembly including a first electrode and a second electrode; a tube body accommodating the electrode assembly therein, the tube body having a tubular shape with a first open end and a second open end; a first film cover installed at the first end of the tube body to seal the first end of the tube body; a first terminal connected to the first electrode and a second terminal connected to the second electrode, wherein the first terminal and the second terminal each protrude through the first film cover at the first end of the tube body; and a second film cover installed at the second end of the tube body to seal the second end of the tube body.

With the exemplary embodiments of the present invention, the heat dissipation characteristic of a rechargeable battery is improved, and the output power per unit weight is enhanced.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a rechargeable battery according to a first exemplary embodiment of the present invention.

FIG. 2 is a cross-sectional view of the rechargeable battery taken along the II-II line of FIG. 1.

FIG. 3 is an exploded perspective view of a tube body and a film cover separated from each other.

FIG. 4 is a perspective view of a rechargeable battery according to a second exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

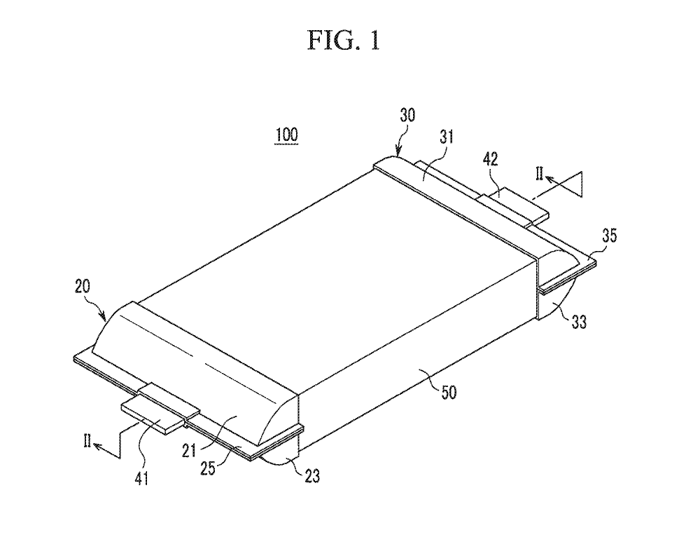

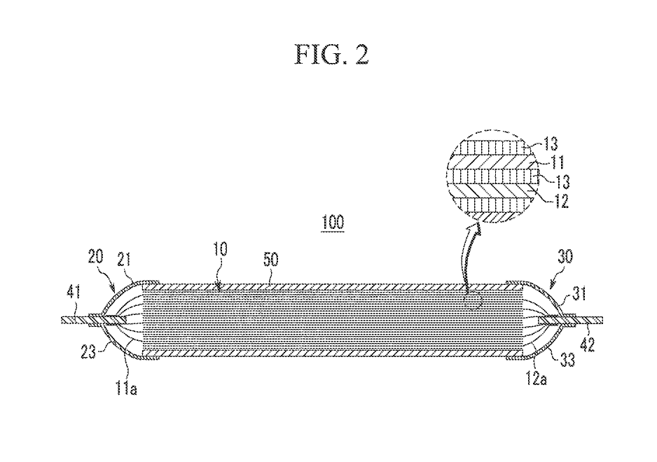

FIG. 1 is a perspective view of a rechargeable battery according to an exemplary embodiment of the present invention, and FIG. 2 is a cross-sectional view of the rechargeable battery taken along the II-II line of FIG. 1.

A rechargeable battery 100 according to the exemplary embodiment of FIGS. 1 and 2 includes an electrode assembly 10 with positive and negative electrodes 11 and 12 and a separator 13 disposed therebetween, a tube body 50 accommodating the electrode assembly 10 therein, a first film cover 20 installed at an end of the tube body 50, and a second film cover 30 installed at the other end of the tube body 50.

The positive electrode 11 has a positive electrode current collector and positive electrode active material layers formed on the positive electrode current collector, while the negative electrode 12 has a negative electrode current collector and negative electrode active material layers formed on the negative electrode current collector. The electrode assembly 10 has a structure in which a plurality of the positive and negative electrodes 11 and 12 are alternately laminated while interposing the separator 13.

However, the present invention is not limited thereto, and the electrode assembly 10 may have a structure in which the separator 13 is disposed between the positive and negative electrodes 11 and 12, and wound.

Positive and negative electrode uncoated regions 11a and 12a are formed at respective ends of the electrode assembly 10. A first terminal 41 is attached to the positive electrode uncoated region 11a through welding, and a second terminal 42 is attached to the negative electrode uncoated region 12a through welding.

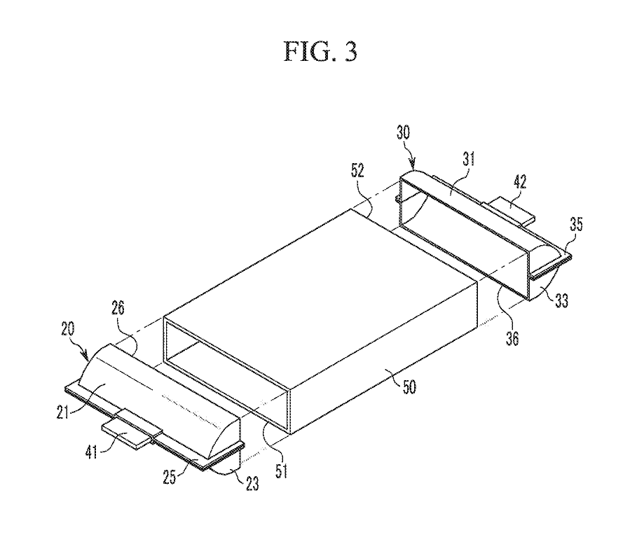

Referring to FIG. 3, the tube body 50 has openings 51 and 52 at respective ends thereof. In other words, the tube body 50 has a tubular structure with open ends. The tube body 50 may be formed of a rigid material such as a metal such as stainless steel, or a polymer. The tube body 50 may have a rectangular cross-section, but is not limited thereto. That is, the tube body 50 may have a various other shapes, such as a cylindrical shape.

The first film cover 20 includes a first film body 21 and a second film body 23 attached thereto. The first and second film bodies 21 and 23 may be formed with a single polymer layer, or with a laminated film where a polymer is coated on both sides of a metal foil. The first film cover 20 has an opening 26 formed by spacing the first and second film bodies 21 and 23 apart from each other at one side, and the remaining three sides thereof, excluding the side with the opening 26, are attached to each other. An attachment flange 25 is formed at the attachment area where the first and second film bodies 21 and 23 are attached to each other.

The attachment flange 25 is disposed at the contact area between the first and second film bodies 21 and 23, and extends to the outside of the first film cover 20. An end of the tube body 50 is inserted into the opening 26 of the first film cover 20 such that the first film cover 20 seals the opening 51 of the tube body 50 formed at the inserted end thereof.

When the first film cover 20 is fitted to the tube body 50, the shape of the first film cover 20 is stabilized by the tube body 50. Furthermore, since the first film cover 20 is made out of a film, the total weight of the rechargeable battery 100 is reduced.

The first terminal 41 electrically connected with the electrode assembly 10 is fitted between the first and second film bodies 21 and 23. The first terminal 41 is electrically connected to the positive electrode 11, and protrudes externally while passing between the first and second film bodies 21 and 23. Accordingly, the first and second film bodies 21 and 23 may be attached to the first terminal 41 while performing an insulating function.

Meanwhile, as with the first film cover 20, the second film cover 30 includes a first film body 31, and a second film body 33 attached to the first film body 31. The second film cover 30 has an opening 36 formed by spacing the first and second film bodies 31 and 33 apart from each other at one side, and the remaining three sides thereof, excluding the side with the opening 36, are attached to each other, An attachment flange 35 is formed at the attachment area.

With the exemplary embodiment of FIGS. 1 and 2, when the open ends of the tube body 50 are sealed by way of the film covers 20 and 30, the metal-based tube body 50 can support the electrode assembly 10 in a stable manner, and since the tube body 50 is sealed by way of the film covers 20 and 30, the weight thereof can be reduced. Accordingly, the output power per unit weight is enhanced. Furthermore, as the film covers 20 and 30 are supported by the attachment flanges 25 and 35, the shape of the film covers 20 and 30 can be stabilized.

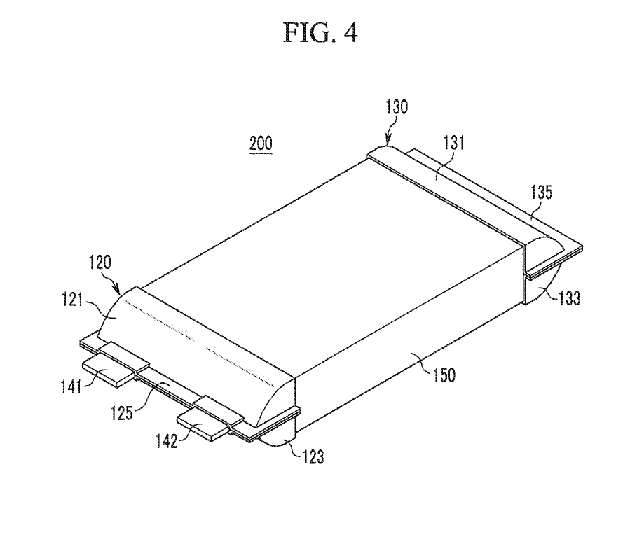

FIG. 4 is a perspective view of a rechargeable battery according to another exemplary embodiment of the present invention.

The rechargeable battery 200 according to the exemplary embodiment of FIG. 4 includes a tubular-shaped tube body 150, an electrode assembly accommodated in the tube body 150, a first film cover 120 attached to one end of the tube body 150, and a second film cover 130 attached to the other end of the tube body 150. The tube body 150 may be made out of a metal, and has a quadrangle-shaped cross-section. It is to be understood that other materials and other cross-sectional shapes may be used.

The first film cover 120 is formed by attaching first and second film bodies 121 and 123 to each other along three sides. The first film cover 120 has an opening formed by spacing the first and second film bodies 121 and 123 apart from each other at a remaining side. Furthermore, an attachment flange 125 that extends externally is formed at the attachment site of the first and second film bodies 121 and 123. The one end of the tube body 150 is inserted into the opening of the first film cover 120 such that the first film cover 120 seals the tube body 150.

A first terminal 141 electrically connected with the positive electrode and a second terminal 142 electrically connected with the negative electrode are fitted between the first and second film bodies 121 and 123, and protrude externally.

The second film cover 130 is formed by attaching first and second film bodies 131 and 133 to each other at three sides while spacing the first and second film bodies 131 and 133 apart from each other to form an opening into which the other end of the tube body 150 is inserted, so as to seal the other end of the tube body 150. An attachment flange 135 is formed at the attachment area where the first and second film bodies 131 and 133 are attached.

Moreover, it is to be understood that in the embodiment of FIG. 4, since the second film cover 130 of the rechargeable battery does not have an electrode protruding therethrough, the structure of the second film cover 130 may be simplified and may differ from what is described herein and from what is shown in FIG. 4.

With the structure according to the exemplary embodiment of FIG. 4, even when the first and second terminals 141 and 142 protrude through the first film cover 120, the covers for sealing the ends of the tube body 150 may be formed with a film. Accordingly, the tube body can be sealed more stably, and the total weight of the rechargeable battery can be reduced.

Although a few embodiments of the present invention have been shown and described, it would be appreciated by those skilled in the art that changes may be made in this embodiment without departing from the principles and spirit of the invention, the scope of which is defined in the claims and their equivalents.

### <Description of Symbols>

FIGS. 1-3

| | |
|---|---|
| 10: electrode assembly | 100: rechargeable battery |
| 11: positive electrode | 11a: positive electrode uncoated region |
| 12: negative electrode | 12a: negative electrode uncoated region |
| 13: separator | 20: first film cover |
| 21, 31: first film body | 23, 33: second film body |
| 25, 35: attachment flange | 26, 36: opening of film body |
| 30: second film cover | 41: first terminal |
| 42: second terminal | 50: tube body |
| 51, 52: opening of tube body | |

FIG. 4

| | |
|---|---|
| 120: first film cover | |
| 121, 131: first film body | 123, 133: second film body |
| 125, 135: attachment flange | |
| 130: second film cover | 141: first terminal |
| 142: second terminal | 150: tube body |

What is claimed is:

1. A rechargeable battery comprising:
an electrode assembly that undergoes charging and discharging;
a tube body accommodating the electrode assembly therein, the tube body having a tubular shape with a first open end and a second open end;
a first film cover installed at the first end of the tube body to seal the first end of the tube body; and
a second film cover installed at the second end of the tube body to seal the second end of the tube body.

2. The rechargeable battery of claim 1, wherein the tube body is a rigid body.

3. The rechargeable battery of claim 2, wherein the tube body is made of a metal.

4. The rechargeable battery of claim 2, wherein the tube body is made of a rigid polymer.

5. The rechargeable battery of claim 1, wherein the first film cover comprises a first film body and a second film body, wherein the first film body and the second film body are attached to each other.

6. The rechargeable battery of claim 1, wherein the first film cover and the second film cover each comprise a first film body and a second film body that are attached to each other.

7. The rechargeable battery of claim 5, wherein the first film cover has an opening formed by spacing the first film body and the second film body apart from each other at one side of the first film cover, and wherein the opening accommodates the first end of the tube body.

8. The rechargeable battery of claim 5, wherein the first film cover includes an attachment flange where the first film body and the second film body are attached to each other, and wherein the attachment flange is disposed along a lateral side of the first film cover.

9. The rechargeable battery of claim 6, further comprising a first terminal electrically connected to a positive electrode of the electrode assembly and protruding through the first film cover, and a second terminal electrically connected to a negative electrode of the electrode assembly and protruding through the second film cover.

10. The rechargeable batter of claim 9, wherein the first terminal protrudes between the first film body and the second film body of the first film cover and the second terminal protrudes between the first film body and the second film body of the second film cover.

11. The rechargeable battery of claim 5, further comprising a first terminal electrically connected with a positive electrode of the electrode assembly and a second terminal electrically connected with a negative electrode of the electrode assembly, wherein the first terminal and the second terminal are disposed at the first film cover such that the first and second terminals each protrude between the first film body and the second film body of the first film cover.

12. The rechargeable battery of claim 5, wherein the first film body and the second film body are each made up of a single polymer layer.

13. The rechargeable battery of claim 5, wherein the first film body and the second film body are each made up of a laminated film comprising polymer layers attached on respective sides of a metal layer.

14. A rechargeable battery comprising:
an electrode assembly including a first electrode and a second electrode;
a tube body accommodating the electrode assembly therein, the tube body having a tubular shape with a first open end and a second open end;
a first film cover disposed at the first end of the tube body to seal the first end of the tube body;
a first terminal connected to the first electrode, wherein the first terminal protrudes through the first film cover at the first end of the tube body;
a second film cover disposed at the second end of the tube body to seal the second end of the tube body; and
a second terminal connected to the second electrode, wherein the second terminal protrudes through the second film cover at the second end of the tube body.

15. A rechargeable battery comprising:
an electrode assembly including a first electrode and a second electrode;
a tube body accommodating the electrode assembly therein, the tube body having a tubular shape with a first open end and a second open end;
a first film cover disposed at the first end of the tube body to seal the first end of the tube body;
a first terminal connected to the first electrode and a second terminal connected to the second electrode, wherein the first terminal and the second terminal each protrude through the first film cover at the first end of the tube body; and
a second film cover disposed at the second end of the tube body to seal the second end of the tube body.
